(19) United States
(12) Patent Application Publication
(10) Pub. No.: US 2026/0107251 A1
(43) Pub. Date: Apr. 16, 2026

(54) METHODS OF SL POSITIONING WITH MULTIPLE REFERENCE WTRUS

(71) Applicant: INTERDIGITAL PATENT HOLDINGS, INC., Wilmington, DE (US)

(72) Inventors: Jung Je Son, Warrington, PA (US); Anuj Sethi, Ottawa (CA); Taimoor Abbas, Sainte-Julie (CA); Zhibi Wang, Woodridge, IL (US); Saad Ahmad, Montreal (CA); Achref Methenni, Montreal (CA)

(73) Assignee: INTERDIGITAL PATENT HOLDINGS, INC., Wilmington, DE (US)

(21) Appl. No.: 19/116,158

(22) PCT Filed: Sep. 28, 2023
(86) PCT No.: PCT/US2023/034030

§ 371 Date: Mar. 27, 2025

Related U.S. Application Data
(60) Provisional application No. 63/410,826, filed on Sep. 28, 2022.
(60) Provisional application No. 63/526,835, filed on Jul. 14, 2023.

(51) Int. Cl. H04W 64/00; H04W 92/18

(52) U.S. Cl. CPC H04W 64/00; H04W 92/18

(57) ABSTRACT

A procedure is provided on how a target WTRU and LMF negotiate for supported WTRU initiated positioning method, and how the target WTRU discovers reference WTRUs for SL positioning and perform proper SL positioning with multiple reference WTRUs. A procedure is provided on how to perform SL positioning between target WTRU and reference WTRUs in coordination with LMF. The proper SL positioning method may be updated when the available number of reference WTRUs change. Each WTRU positioning method needs a different number of reference WTRUs for SL positioning. As the WTRU moves around, there may not be enough reference WTRUs available for SL positioning. A negotiation may be considered between the WTRU and network for a positioning method to be employed. When certain WTRU positioning methods are not possible, the requested positioning method may be updated to one or more other available positioning methods.

### CROSS REFERENCE TO RELATED APPLICATIONS

This application claims the benefit of U.S. Provisional Application Ser. No. 63/410,826, filed Sep. 28, 2022, and U.S. Provisional Application Ser. No. 63/526,835, filed Jul. 14, 2023, which are incorporated by reference as if fully set forth.

### BACKGROUND

Even though a WTRU is in the coverage of the 5G system, there are some cases when the WTRU is not available for Uu based positioning. This lack of availability may happen, for example, because of lack of a number of gNBs reachable. In such cases, positioning of WTRU using PC5 channel, i.e. SL positioning, is considered to acquire the WTRUs location. In order to perform SL positioning, the WTRU may need to connect multiple WTRUs for a given one or more WTRU positioning methods. Information about the WTRUs which are connected via PC5 and involved for SL positioning of the WTRU is also needed at the NW, including for example, for assigning resource for PC5 connection, for sharing assistance information for SL positioning, or for coordination on WTRU to gather enough measurement information to determine WTRU's position.

### SUMMARY

According to examples, when selecting SL positioning method, a target WTRU reports a list of available reference WTRUs and the LMF considers the reported reference WTRU's list from the target WTRU.

According to examples, when a requested SL positioning cannot be fulfilled because of lack of available reference WTRUs, the target WTRU may negotiate with the LMF for a SL positioning method.

The WTRU may initiate a location request with multiple reference WTRUs when WTRU is in coverage. SL based Location request may be initiated by the target WTRU when it is in coverage. An overall procedure is provided on how a target WTRU and LMF negotiate for supported WTRU initiated positioning method, and how target WTRU discovers Reference WTRUs for SL positioning and perform proper SL positioning with multiple reference WTRUs.

The NW initiated location request may be supported with multiple reference WTRUs when WTRU is in coverage. SL based Location request may be initiated by NW. A target WTRU may be triggered for discovering and setting up the connection with reference WTRUs after receiving location request from the LMF. With this consideration, an overall procedure is provided on how to perform SL positioning between target WTRU and Reference WTRUs in coordination with LMF.

The proper SL positioning method may be updated when the available number of reference WTRUs change. Each WTRU positioning method needs a different number of Reference WTRUs for SL positioning. As the WTRU moves around, there may not be enough Reference WTRUs available for SL positioning. A negotiation may be considered between the WTRU and Network for a positioning method to be employed. When certain WTRU positioning methods are not possible, the requested positioning method may be updated to one or more other available positioning methods.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates is a reference model of a potential architecture of 5G or NextGen network;

FIG. 3 illustrates a reference model of 5G/NextGen Network for Location Services;

FIG. 4 illustrates an NR positioning CP/UP architecture that may use defined protocols to enable several positioning technologies and methods;

FIG. 5 illustrates a 5G MO-LR signaling diagram with multiple Reference WTRUs;

FIG. 6 illustrates a 5G MT-LR signaling diagram with multiple Reference WTRUs;

FIG. 7 illustrates the signaling associated with a positioning method update procedure; and

FIG. 8 illustrates a method of sidelink (SL) positioning in a wireless transmit receive unit (WTRU).

### DETAILED DESCRIPTION

A system, method and device for SL positioning with multiple reference WTRUs are described.

The method of sidelink (SL) positioning in a wireless transmit receive unit (WTRU) includes triggering a location request, wherein the location request includes one or more quality metrics, discovering at least one SL reference WTRU, determining a list of available references WTRUs, wherein the list includes the at least one SL reference WTRU, the inclusion of the at least one SL reference WTRU being based on at least one of the one or more quality metrics, sending a SL positioning service request to a network, the SL positioning service request including the list of available reference WTRUs, negotiating SL positioning capability with the network in view of the list of available reference WTRUs, receiving assistance information from the network, and using the assistance information to perform a SL positioning procedure via the negotiated SL positioning capability. The discovered at least one SL reference WTRU may be identified in a mobile originated location request. The method may include, upon a condition that reference WTRUs are lacking, renegotiating SL positioning capability with the network based on the list of available reference WTRUs. The one or more quality metrics may include at least one of the group consisting of accuracy, response time, and LCS QoS class. The assistance information may include information for communicating with at least one WTRU from the list of available reference WTRUs. The assistance information may include acquisition assistance data. The using of the assistance information may include utilizing at least one of accessible sources of positioning, measures, and processes of positioning signals. The method may include computing the position of the WTRU in two or more dimensions and reporting the position to the network. The negotiating SL positioning capability with the network may include sending a request comprising a preferred capability and a list of supported capabilities and receiving a response to the sent request indicating a SL positioning procedure. The method may include indicating one or more priority levels associated with the SL positioning procedures and selecting the procedure to use based on the indicated one or more priority levels. The indicating and selecting may be performed via the network.

The wireless transmit receive unit (WTRU) for sidelink (SL) positioning includes a processor, and a transceiver communicatively coupled to the processor. Thee processor and transceiver operating to trigger a location request, wherein the location request includes one or more quality metrics, discover at least one SL reference WTRU, determine a list of available references WTRUs, wherein the list includes the at least one SL reference WTRU, the inclusion of the at least one SL reference WTRU being based on at least one of the one or more quality metrics, send a SL positioning service request to a network, the SL positioning service request including the list of available reference WTRUs, negotiate SL positioning capability with the network in view of the list of available reference WTRUs, receive assistance information from the network, and use the assistance information to perform a SL positioning procedure via the negotiated SL positioning capability. The discovered at least one SL reference WTRU may be identified in a mobile originated location request. The processor and transceiver may further operate to, upon a condition that reference WTRUs are lacking, renegotiate SL positioning capability with the network based on the list of available reference WTRUs. The one or more quality metrics may be at least one of the group consisting of accuracy, response time, and LCS QoS class. The assistance information may be information for communicating with at least one WTRU from the list of available reference WTRUs. The assistance information may be acquisition assistance data. The processor and transceiver may further operate to compute the position of the WTRU in two or more dimensions, and report the position to the network. The negotiating SL positioning capability with the network may include the processor and transceiver further operating to send a request comprising a preferred capability and a list of supported capabilities, and receive a response to the sent request indicating a SL positioning procedure. The processor and transceiver may further operate to indicate one or more priority levels associated with the SL positioning procedures, and select the procedure to use based on the indicated one or more priority levels.

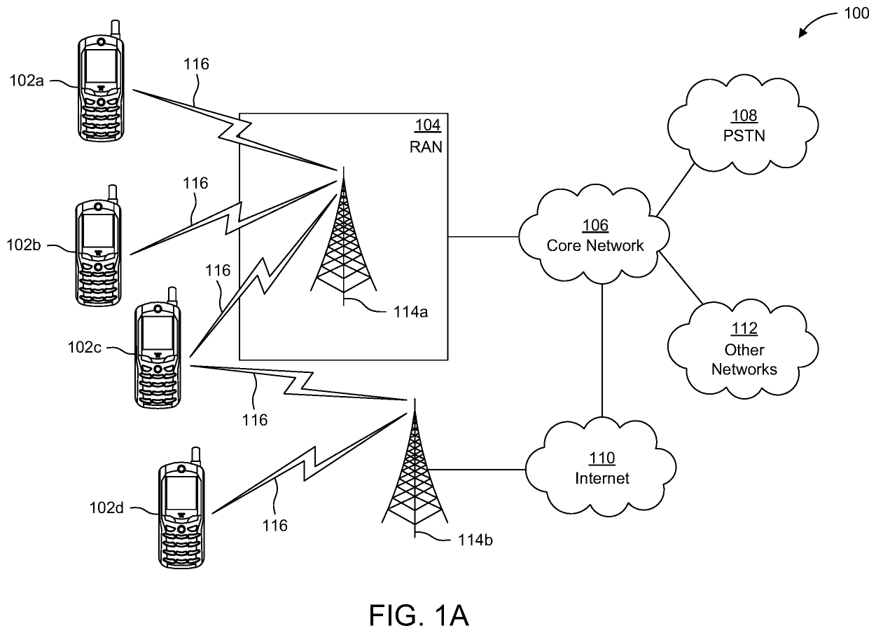

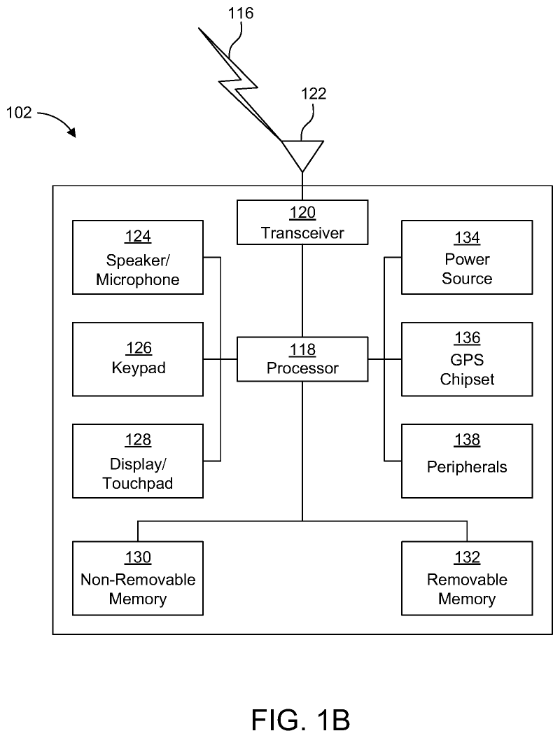

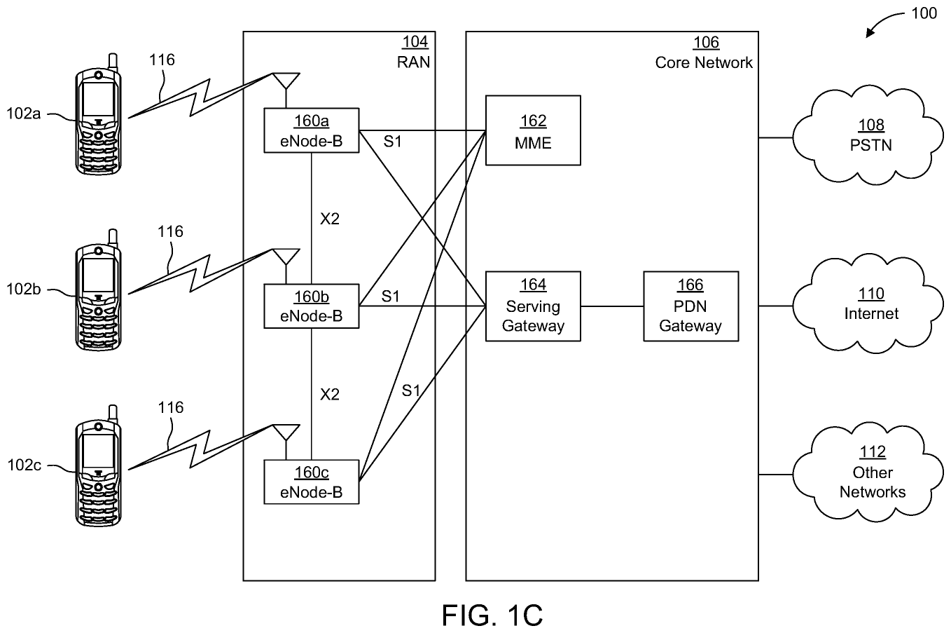

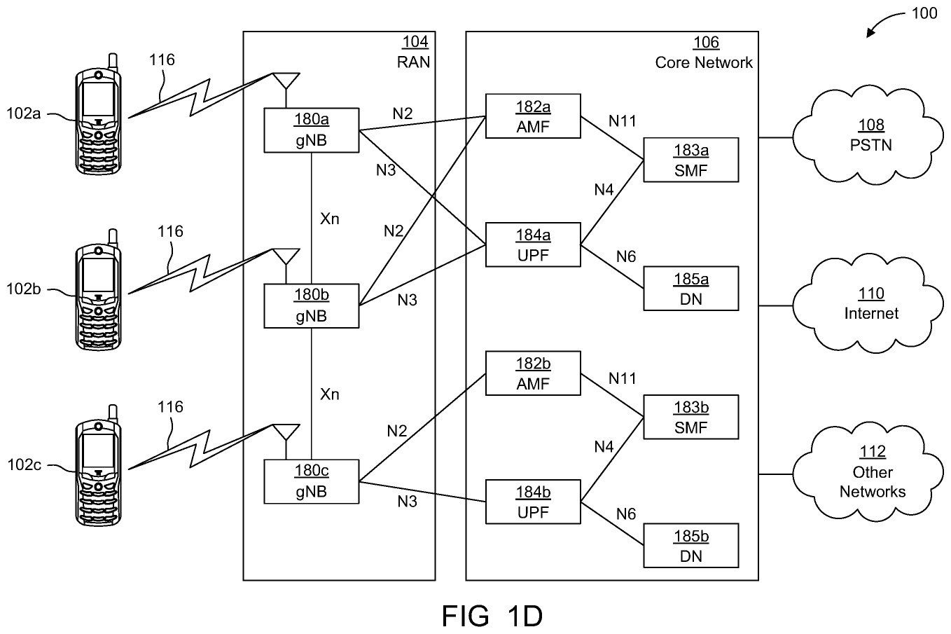

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP). a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a. 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a. 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a. 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a. 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b. 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a. 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

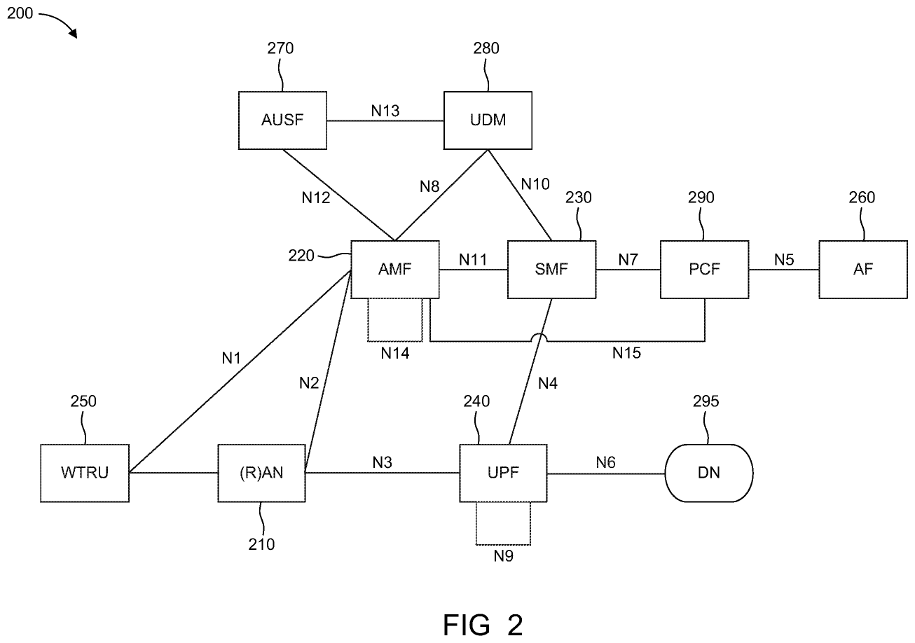

FIG. 2 illustrates is a reference model 200 of a potential architecture of 5G or NextGen network. The architecture of model 200 specifies discrete interfaces between control-plane elements. RAN 210 refers to a radio access network based on the 5G RAT or Evolved E-UTRA that connects to the NextGen core network. The Access Control and Mobility Management Function (AMF) 220 at least includes the following functionalities, Registration management, Connection management, Reachability management, Mobility Management, etc. The Session Management Function (SMF) 230 at least includes the following functionalities, session management (including session establishment, modify and release), WTRU IP address allocation, selection and control of UP function, etc. The User plane function (UPF) 240 at least includes the following functionalities, packet routing & forwarding, packet inspection, traffic usage reporting, etc.

5G location service (LCS) may provide functionality to provide the positioning information of a WTRU 250. The positioning of WTRU 250 may be supported by RAT dependent position method. A RAT dependent position method may rely on, for example, 3GPP RAT measurements obtained by a target WTRU and/or on measurement obtained by an Access Network of 3GPP RAT signals transmitted by a target WTRU. Positioning of a WTRU may be supported by RAT independent position methods. A RAT independent position method may rely on non-RAT measurements obtained by a WTRU and/or on other information. Location information for one or multiple target WTRUs may be requested by and reported to an LCS client or an application function (AF) 260 within or external to a 3GPP operator network, or a control plane NF within 3GPP system. For location request from LCS client or AF 260, privacy verification of the target WTRU may be enabled to check whether it is allowed to acquire the WTRU location information.

Several different types of location requests may be supported. A Mobile Terminated Location Request (MT-LR) that may occur with a Mobile Terminated Location Request (MT-LR), an LCS client or AF sends a location request to the 5G Network for the location of a target WTRU. A Mobile Originated Location Request (MO-LR) that may occur with a Mobile Originated Location Request (MO-LR), a WTRU sends a request to the 5G Network for location related information for the WTRU. An Immediate Location Request that occurs with an immediate location request, an LCS client or AF 260 sends or instigates a location request for a target WTRU(s) and expects to receive a response containing location information for the target WTRU(s) within a short time period. The Immediate Location Request may be used for an MT-LR or MO-LR. A Deferred Location Request that occurs with a deferred location request, an LCS client or AF 260 sends a location request to the 5G network for a target WTRU(s) and expects to receive a response when an indicated event occurred for the target WTRU at some future time. It may be used for an MT-LR.

Authentication server function (AUSF) 270 validates the identity of a user and providing access to the network resources based on their security level.

Unified data management (UDM) 280 stores and manages the user's data, including their IMSI and authentication data. UDM 280 provides other network function, i.e., AMF 220, SMF 230, for example, with the user's data, e.g., authentication data, when requested.

Policy control function (PCF) 290 is responsible for enforcing the policies that govern the user's access to the network resources. PCF 290 provides other network function, i.e., AMF 220, SMF 230, for example, with the user's policy data when requested. Data network (DN) 295 is within the system as illustrated, and is described herein.

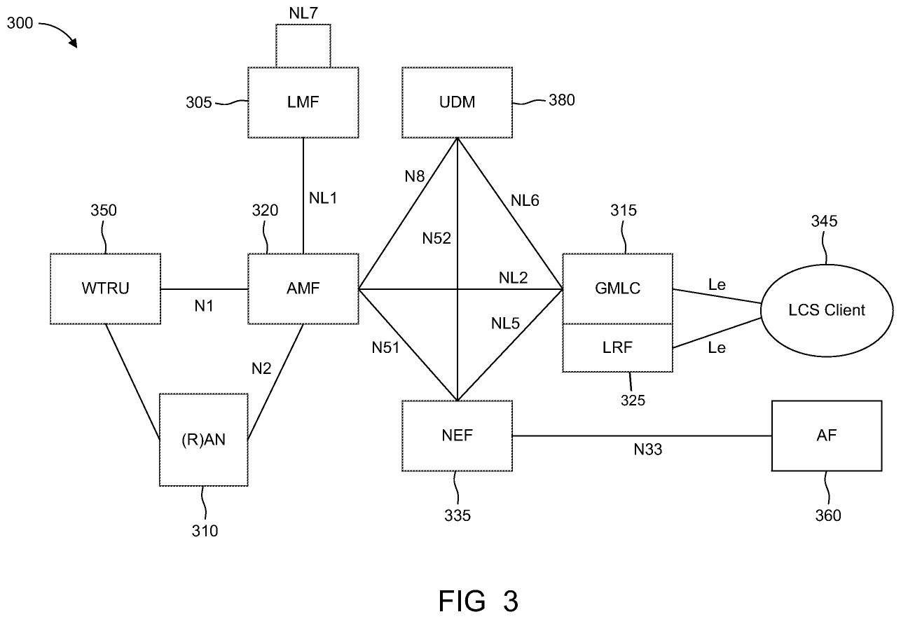

FIG. 3 illustrates a reference model 300 of 5G/NextGen Network for Location Services. (R)AN 310 represents NG-RAN, trusted non-3GPP access or untrusted non-3GPP access. Access network is involved in the handling of various positioning procedures including positioning of a target WTRU, provision of location related information not associated with a particular target WTRU and transfer of positioning messages between an AMF 320 or LMF 305 and a target WTRU. AF 360 and NF may access LCS services from a Gateway Mobile Location Centre (GMLC) 315 in the same 3GPP operator network. LCS client 345 may access LCS services from a GMLC 315 and External AF 360 may access LCS service from a NEF 335. GMLC 315 handles the request from external LCS client 345, AF 360. via NEF 335 if AF 360 is an external AF 360, and forward location request to the proper NF. A Location Retrieval Function (LRF) 325 is responsible for retrieving or validating location information and may be collocated with an GMLC 315 or separate. A Location Management Function (LMF) 305 manages the overall co-ordination and scheduling of resources required for the location of a WTRU 350 that is registered with or accessing 5GCN. LMF 305 may calculate or verifies a final location related information and achieved accuracy.

Unified data management (UDM) 380 stores and manages the user's data, including their IMSI and authentication data. UDM 380 provides AMF 320, GMLC 315, and NEF 335 with the user's data, e.g., privacy profile or subscription data for location service, when requested.

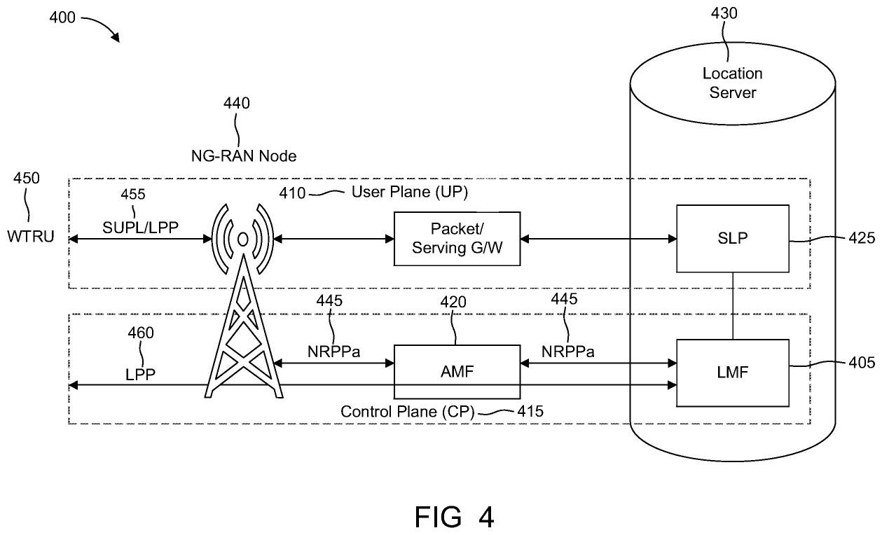

FIG. 4 illustrates an NR positioning CP/UP architecture 400 that may use defined protocols to enable several positioning technologies and methods (GNSS, sensors, positioning signals, etc.). Positioning protocols and RAN-based positioning signals have been specified for enabling emergency services and location-based services.3GPP NR positioning protocols are supported by the Control Plane (CP) 415 positioning architecture over the Uu interface (NG-RAN node to WTRU). The NR positioning architecture may also be supported by a Secure User Plane Location (SUPL) server, also known as a SUPL Location platform (SLP) 425 or location server 430, that may leverage any IP bearer. Interworking for CP 415 and User Plane (UP) 410 provide positioning solutions and SUPL 455 may also be used as a tunnel for CP positioning protocols (e.g., LPP 460) as is illustrated in FIG. 4.

The primary protocol, LTE Positioning protocol (LPP) 460, is terminated between WTRU 450 and Location Management Function (LMF) 405. LPP 460 is a Point-to-Point LCS and NAS messaging protocol. LPP 460 has been agreed to be re-used for NR and continues to be leveraged for the foreseeable future. Radio Resource Control (RRC) is another protocol used to provide transport for LPP messages and other positioning procedures over the NR-Uu interface, which is terminated between the gNB and WTRU 450. On the network side, NG Application Protocol (NGAP) is terminated between AMF 420 and the NG-RAN Node(s) 440 (i.e., gNB/TRP) and is used as a transport for LPP 460 and NRPPa 445 messages over the NG-C interface. Finally, NR Positioning Protocol A (NRPPa) 445 carries information between the NG-RAN Node(s) 440 and LMF 405.

In the NR Positioning modes, positioning may be performed as a Standalone, WTRU-Based, or WTRU-Assisted modes. In Standalone positioning, WTRU 450 handles all aspects of the positioning, scans for accessible sources of positioning, measures, and processes positioning signals/sources. Finally, WTRU 450 computes its own position in 2 or 3 dimensions. In Standalone positioning. the Uu interface impacts include WTRU capability exchange and reporting of the WTRU position. In WTRU-Based Positioning (WTRU-B), the network provides acquisition assistance data, and WTRU 450 scans for accessible sources of positioning, measures, and processes positioning signals/sources (based on assistance information from the network). Finally, WTRU 450 computes its own position in 2 or 3 dimensions and may report its position to the network.

In WTRU-Assisted Positioning (WTRU-A), the network provides acquisition assistance, and WTRU 450 scans for accessible sources of positioning, measures positioning signals/sources (based on assistance information from NW). Finally, WTRU 450 returns measurements to the network, and the network computes the device position (at the location server 430/LMF 405).

The following table (TABLE 1) provides supported techniques of WTRU positioning methods.

TABLE 1
Supported Techniques of WTRU Positioning Methods

| Method | WTRU-based | WTRU-assisted, LMF-based |
|---|---|---|
| DL-TDOA | Yes | Yes |
| DL-AoD | Yes | Yes |
| Multi-RTT | No | Yes |
| NR E-CID | No | Yes |
| UL-TDOA | No | No |
| UL-AoA | No | No |

In LPP 460, LPP messages related to WTRU-assisted location request(s) includes at least the following procedures:
Request Capabilities, such as LMF 405 request to WTRU 450;
Provide Capabilities, such as WTRU 450 response to LMF 405;
Request Assistance Data, such as WTRU 450 request to LMF 405 for positioning assistance data/information;
Provide Assistance Data, such as LMF 405 to WTRU positioning assistance data information/configuration (additionally, broadcast of positioning Assistance Data (AD) is supported via Positioning System Information Blocks (posSIBs) and carried in SI messages);
Request Location Information, such as LMF 405 request to WTRU 450 for position/measurements;
Provide Location Information, such as WTRU 450 to LMF 405, position and/or measurements;
Abort, such as Abort LPP session; and
Error, such as Errors associated with positioning procedure(s).

The QoS Requirement and LCS QoS Class of a location request may indicate the accuracy or response time of a Location Response. Since the QoS Requirement and LCS QoS Class may indicate an accuracy requirement, the QoS Requirement and LCS QoS Class may be used to determine the procedure that is to be used to perform a location calculation. Since the QoS Requirement and LCS QoS Class may indicate an accuracy requirement, the QoS Requirement and LCS QoS Class may be used to determine how many other WTRUs a first WTRU may interact with in order to perform a location calculation. For example, it may be possible to improve the accuracy of a location calculation by collecting location information from a larger number of WTRUs and using the location information from the other WTRUs to improve the accuracy of the location calculation. Since the QoS Requirement and LCS QoS Class may indicate a response time, the QoS Requirement and LCS QoS Class may be used to determine the procedure that is to be used to perform a location calculation. For example, a QoS Requirement and LCS QoS Class that is indicative of a relatively small response time may be used to determine to use a location calculation procedure that takes a relatively short amount of time.

Even though a WTRU is in the coverage of the 5G system, there are some cases that WTRU is not available for Uu based positioning, for example because of lack of number of gNBs reachable. For those cases, positioning of WTRU using PC5 channel, i.e. SL positioning, is considered to acquire WTRU's location. In order to perform SL positioning, the WTRU may need to connect multiple WTRUs per WTRU positioning methods. Information about WTRUs which are connected via PC5 to and involved for SL positioning of the WTRU is also needed at NW for example for assigning resource for PC5 connection, for sharing assistance information for SL positioning, or for coordination on WTRU to gather enough measurement information to determine WTRU's position.

WTRU 450 may initiate a location request with multiple reference WTRUs when WTRU is in coverage. SL based Location request may be initiated by the target WTRU when it is in coverage. An overall procedure is provided on how a target WTRU and LMF 405 negotiate for supported WTRU initiated positioning method, and how target WTRU discovers Reference WTRUs for SL positioning and perform proper SL positioning with multiple reference WTRUs.

The NW initiated location request may be supported with multiple reference WTRUs when WTRU is in coverage. SL based Location request may be initiated by NW. In this case, a target WTRU may be triggered for discovering and setting up the connection with reference WTRUs after receiving location request from LMF 405. With this consideration, an overall procedure is provided on how to perform SL positioning between target WTRU and Reference WTRUs in coordination with LMF 405.

The proper SL positioning method may be updated when the available number of reference WTRUs change. Each WTRU positioning methods needs a different number of Reference WTRUs for SL positioning. As WTRU 450 moves around, there may not be enough Reference WTRUs available for SL positioning. In this case, it may be considered when negotiate positioning method between WTRU 450 and Network. When certain WTRU positioning methods are not possible, the requested positioning method may be updated to other available positioning methods.

WTRU 450 may to support PC5 Signaling. PC5 signaling may be supported by the ProSe layer in the WTRUs, for example. WTRU 450 in examples described include the capability of ranging and sidelink positioning. Sidelink positioning generally refers to the positioning via PC5 interface and ranging refers to the determination of the distance between two WTRUs or more WTRUs and/or the direction and/or relative positioning of one WTRU from another WTRU.

For 5G MO-LR request, the target WTRU may check the available reference WTRU and target WTRU may inform the available reference WTRU to Network. LMF 405 may consider the available reference WTRUs, target WTRU's capability, and QoS requirement to determine the SL positioning method. After deciding SL positioning method, LMF 405 may inform target WTRU and involved reference WTRUs. Target WTRU and reference WTRUs perform SL positioning and inform the result to LMF 405.

From 5G MT-LR request, the target WTRU and LMF 405 may communicate for capability negotiation for SL positioning. During this, target WTRU may inform available reference WTRUs to LMF 405 and LMF 405 may decide SL positioning method based on the list of reference WTRUs, target WTRU's capability, and QoS requirement. After deciding SL positioning method by LMF 405, target WTRU and reference WTRUs perform SL positioning as requested by LMF 405.

When the target WTRU cannot perform requested SL positioning by LMF 405 because of lack of available reference WTRUs, the target WTRU may provide this information to LMF 405. LMF 405 may perform another SL positioning method to WTRU 450 with consideration of available reference WTRUs, target WTRU's capability, and QoS requirement. The target WTRU may perform SL positioning as indicated by LMF 405 with available reference WTRUs.

The NW may provide the list of reference WTRUs and discovery/selection configuration parameters and NW may provide the list of configuration with respect to SL positioning methods with priority and other details.

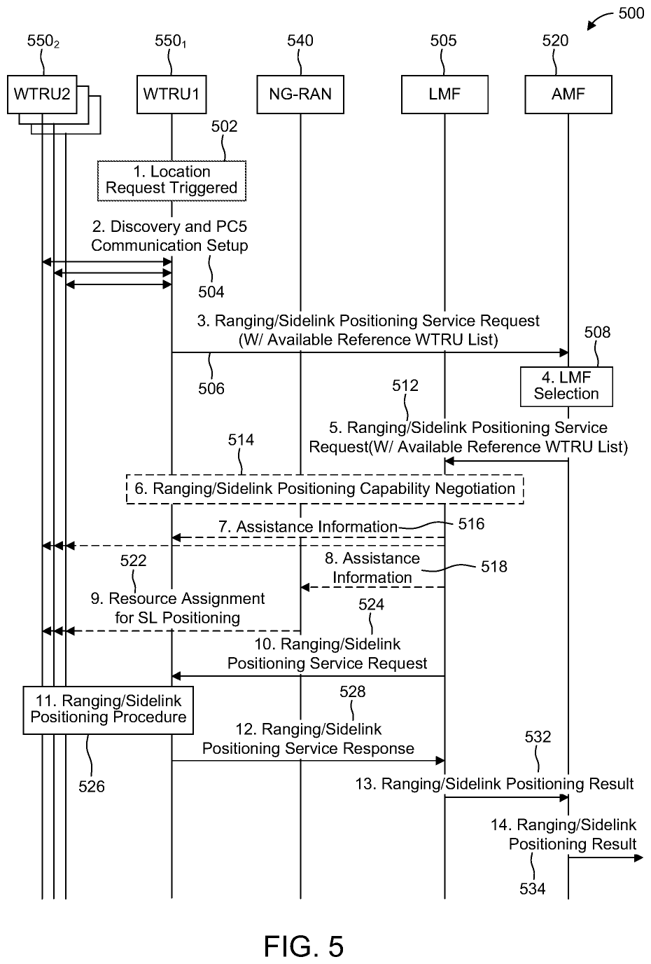

FIG. 5 illustrates a 5G MO-LR signaling diagram 500 with multiple Reference WTRUs. WTRU 1 5501 may be triggered for a location request at 502. The location request may include its destination, for example an LCS client or AF. The location request may include some QoS requirement that are needed (e.g., accuracy, response time, LCS QoS Class).

For example, Application at WTRU 1 550₁ may trigger an location request to send WTRU 1's 550₁ location with some QoS requirements to an AF or an LCS client. For example, a WTRU hosted application may determine to trigger a location request when the application is started, upon a user request that is entered via a GUI, or upon expiration of a time period.

As another example, WTRU 1 550₁ may be configured with some triggering condition for an location report with some QoS requirement to an AF or an LCS client by 5GC system. For example, a WTRU may be configured to trigger a location request upon expiration of a time period.

WTRU 1 550₁ may discover reference WTRUs (i.e., WTRU 2 5502, WTRU 3, WTRU 4, . . . ). Based on QoS requirement of the location request and WTRU 1's 550₁ capability on SL positioning. WTRU 1 550₁ may select number of reference WTRUs (depicted as WTRU 2 550₂) which are needed for SL positioning satisfying QoS requirement and may setup PC5 connection with selected WTRUs at 504. When selecting reference WTRUs, WTRU 1 550₁ may select as many reference WTRUs as required to support SL positioning satisfying highest QoS requirement of the location request. If the available reference WTRU's are not enough to perform SL positioning satisfying highest QoS requirements, WTRU 1 550₁ may select as many reference WTRUs as possible. Alternatively, WTRU 1 550₁ may defer setting up PC5 connection with selected WTRUs later for example after receiving SL positioning Service Request from LMF 505, which may include selected positioning method and/or a selected list of reference WTRUs.

WTRU 1 550₁ may send AMF 520 a Ranging/Sidelink positioning service request at 506 which may include its destination information. Destination information may include, for example, an LCS client or AF and required QoS information. WTRU 1 550₁ may include available Reference WTRU's list in the Ranging/Sidelink positioning service request. WTRU 1 550₁ may include indication of preference to the Reference WTRU's list or may order Reference WTRU in the list per its preference. The preference may be, for example, per signal strength, delay, or PLMN.

AMF 520 may select an LMF 505 at 508 to handle location request from WTRU 1 550₁.

AMF 520 may send a Ranging/Sidelink positioning service request with available reference WTRU list at 512 to the selected LMF 505. AMF 520 may inform LMF 505 of WTRU 1's 550₁ capabilities for positioning.

LMF 505 and WTRU 1 550₁ may communicate to exchange SL positioning capability negotiation at 514. This communication may be used to communicate the WTRU's sidelink positioning capabilities from WTRU 1 550₁ to LMF 505. For example, LMF 505 may send Capability REQ to WTRU 1 550₁ to ask WTRU 1's 550₁ SL positioning capability (e.g., supported positioning methods) and WTRU 1 550₁ may respond LMF 505 with a Capability response that includes WTRU 1's 550₁ SL positioning capability (e.g., supported positioning methods such as DL-TDOA, DL-AOA, etc.).

Alternatively, WTRU 1 550· may perform discovery procedure of available reference WTRUs (i.e. WTRU 2 550₂, WTRU 3, WTRU 4, . . . ) and inform the list of available reference WTRUs during SL positioning capability negotiation or as separate signaling procedure.

LMF 505 may select a positioning method based on QoS information included in the location request, negotiated WTRU 1's 550₁ capability on SL positioning, and available reference WTRU's list from WTRU 1 550₁. LMF 505 may select list of reference WTRUs among ones in the list to join for SL positioning with WTRU 15501. When LMF 505 selects the list of reference WTRUs, LMF 505 may select reference WTRUs as many as required for the selected QoS, more reference WTRUs than the required for the selected QoS, or all the WTRUs in the list with or without prioritization order. After selecting positioning method, LMF 505 may send assistance information to the selected Reference WTRUs for SL positioning with WTRU 1 550₁ at 516. For example, the assistance information at 516 may include information about selected reference signals which are to be used for positioning with the selected positioning method such as DL-TDOA, DL-AOA, etc. For example, the assistance information at 516 may include information that is used by the WTRU for communicating with at least one WTRU that is selected from the list. Communicating with one at least one WTRU that is selected from the list may include performing a sidelink positioning procedure with the at least one WTRU that is selected from the list. For example, the assistance information at 516 may include information that is used by the WTRU to receive a reference signal from WTRU that is selected from the list and use information from the reference signal in a location calculation. When LMF 505 selects from the list of reference WTRUs, LMF 505 may consider indication of preferences to the Reference WTRUs from WTRU 1 550₁, if available.

LMF 505 may send assistance information to NG-RAN 540 at 518. The assistance information at 518 may indicate WTRU 1 550₁ and selected list of reference WTRUs, for example, when resource assignment for SL positioning is needed. NG-RAN 540 may make resource assignment of Reference WTRUs for SL positioning at 522.

Some of the above described signaling may occur when the Reference WTRUs do not belong to the same PLMN as the target WTRU.

LMF 505 may send Ranging/SL positioning Service Request to WTRU 1 550₁ at 524. LMF 505 may indicate a selected positioning method. LMF 505 may include a selected list of reference WTRUs. If the selected list of reference WTRUs is not included in the request from LMF 505, WTRU 1 550₁ may consider every reference WTRU included in the request (Ranging/Sidelink positioning service request) for involvement in SL positioning.

WTRU 1 550₁ and the selected References WTRUs (depicted as WTRU 2 550₂) may perform Ranging/SL positioning procedures at 526. The location information of Reference WTRUs may be shared with WTRU 1 550₁. Before performing Ranging/SL positioning procedures at 526, WTRU 1 550₁ and the selected References WTRU(s) may setup PC5 connection(s) if there is no PC5 connection already available for SL positioning.

WTRU 1 550₁ may send SL positioning result to LMF 505 at 528.

LMF 505 may determine the location of WTRU 1 550₁ based on received SL positioning result and known location of reference WTRUs. If needed, LMF 505 may perform Uu positioning with the reference WTRU, if the reference WTRU is available for Uu positioning with LMF 505. LMF 505 may send WTRU 1's 550₁ location to AMF 520 at 532 as requested above.

AMF 520 may send WTRU 1's 550₁ location to the indicated destination at 534 as provided above.

As an alternative, or in addition to the discovery of reference WTRUs above, AMF 520 or LMF 505 may provide list of Reference WTRUs per known WTRU's location and the WTRU may provide an available Reference WTRU list as a response after performing discovery or a PC5 connection setup procedure. In this case, selection of positioning method may be performed after receiving reference WTRU list and may be shared.

Alternatively, or additionally, determination of location of the target WTRU may be performed by LMF 505, target WTRU or other location server (in a WTRU or in a NW entity). When determination of location is performed by the target WTRU, WTRU 1 550₁ may send the determined location information to LMF 505. Further signaling exchange(s) may be made if LMF 505 or WTRU 1 550₁ act to exchange further information to determine precise WTRU location. When a determination of location is performed by the other location server, WTRU 1 550₁ or LMF 505 may send SL positioning result and other information, for example, such as location information of reference WTRUs, to the location server, respectively. After the location server determines the location information of WTRU 1 550₁, the location server may send the location information to LMF 505.

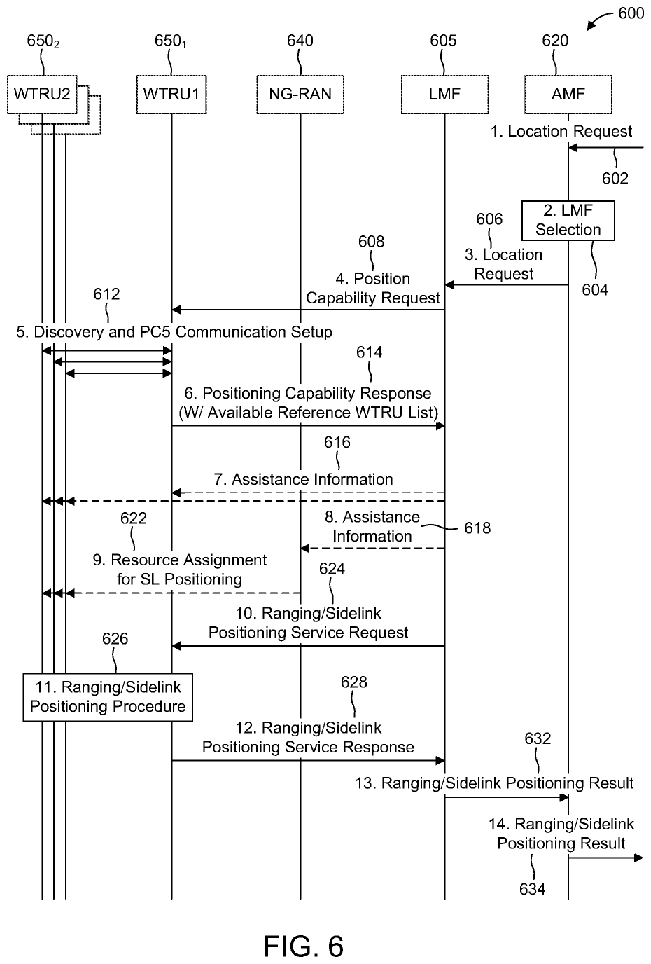

FIG. 6 illustrates a 5G MT-LR signaling diagram 600 with multiple Reference WTRUs. AMF 620 may receive a Location Request requesting location information of WTRU 1 650₁ at 602 from an LCS client or AF via GMLC and/or NEF. The location request may include some QoS requirements to be met (e.g., accuracy, response time, LCS QoS Class).

AMF 620 may select LMF 605 for handling location service of WTRU 1 650₁ at 604.

AMF 620 may forward LMF 605 Location Request at 606 for positioning with WTRU 1 650₁ which may include QoS requirement as received.

LMF 605 may communicate with WTRU 1 650₁ to determine WTRU 1's 650₁ capability for Uu or SL based positioning method at 608. LMF 605 may provide a list of potential Reference WTRUs per WTRU's location and information needed to discover and set PC5 connection.

After receiving the positioning capability request of 608 from LMF 605, WTRU 1 650₁ may check whether Uu based positioning is available or whether SL based positioning is available, for example, based on a channel monitoring result on available number of cells, based on discovered number of reference WTRUs, or based on registered PLMN information. WTRU 1 650₁ may discover reference WTRUs (i.e., WTRU 2 6502, WTRU 3, WTRU 4, . . . ) at 612 for SL positioning. When provided with a list of potential Reference WTRUs, WTRU 1 650₁ may try to discover reference WTRUs among those Reference WTRUs in the list.

Based on WTRU 1's 650₁ capability on SL positioning, i.e., supported SL positioning methods, WTRU 1 650₁ may select number of reference WTRUs and may setup a PC5 connection with a selected WTRU(s). If the QoS requirement was informed from LMF 605, when selecting reference WTRUs, WTRU 1 650₁ may select as many reference WTRUs as required to support SL positioning satisfying highest QoS requirement of the location request. If the available reference WTRU's are not sufficient to perform SL positioning by satisfying highest QoS requirements or QoS requirement is not informed, WTRU 1 650₁ may select as many reference WTRUs as possible. Alternatively, WTRU 1 650₁ may defer setting up PC5 connection with selected WTRUs later for example after receiving SL positioning Service Request from LMF 605, which may include selected positioning method and/or a selected list of reference WTRUs.

Alternatively, WTRU 1 650₁ may inform the list of available reference WTRUs during SL positioning capability negotiation or as separate signaling procedure.

WTRU 1 650₁ may send LMF 605 a positioning capability response at 614 including WTRU 1's 650₁ capability for positioning (e.g., supported positioning methods such as DL-TDOA, DL-AOA, etc.). WTRU 1 650₁ may indicate whether Uu positioning is available and/or SL positioning is available. WTRU 1 650₁ may include information on available cells for Uu positioning and/or list of available reference WTRUs for SL positioning. WTRU 1 650₁ may include indication of preference to the Reference WTRU's list or may order Reference WTRU in the list per its preference. The preference may be for example per ProSe App code, ProSe App ID, PLMN, or monitored signal quality between WTRU 1 650₁ and reference WTRU (e.g., average SINR).

LMF 605 may select a positioning method based on the QoS information included in the location request, negotiated WTRU 1's 650₁ capability on SL positioning, and available reference WTRU's list from WTRU 1 650₁. When a SL positioning method is selected, LMF 605 may select a list of reference WTRUs from among those in the list to join WTRU 1 650₁ for SL positioning. When LMF 605 selects a list of reference WTRUs. LMF 605 may select a number of reference WTRUs as required for the selected QoS, more reference WTRUs than required for the selected QoS, or even all the ones in the list. After selecting a positioning method, LMF 605 may send assistance information at 616 to the selected Reference WTRUs for SL positioning with WTRU 1 650₁. For example, the assistance information at 616 may include information about selected reference signals which is to be used for positioning with the selected positioning method such as DL-TDOA, DL-AOA, etc. For example, the assistance information at 616 may include information that is used by the WTRU for communicating with at least one WTRU that is selected from the list. Communicating with one at least one WTRU that is selected from the list may include performing a sidelink positioning procedure with the at least one WTRU that is selected from the list. For example, the assistance information at 616 may include information that is used by the WTRU to receive a reference signal from WTRU that is selected from the list and use information from the reference signal in a location calculation. When LMF 605 selects a list of reference WTRUs, LMF 605 may consider an indication of preferences to the Reference WTRUs from WTRU 1 650₁ if available.

LMF 605 may send assistance information at 618 to NG-RAN 640. The assistance information at 618 may indicate WTRU 1 650₁ and a selected list of reference WTRUs, for example, when resource assignment for SL positioning is needed.

NG-RAN 640 may make resource assignment of Reference WTRUs for SL positioning at 622.

The signaling described above may be omitted when the Reference WTRUs do not belong to the same PLMN as the target WTRU.

LMF 605 may send Ranging/SL positioning Service Request to WTRU 1 650₁ at 624. LMF 605 may indicate a selected positioning method. LMF 605 may include a selected list of reference WTRUs. If the selected list of reference WTRUs is not included in the request from LMF 605, WTRU 1 650₁ may consider every reference WTRU included in the request may be involved in SL positioning.

WTRU 1 650₁ and selected References WTRUs may perform Ranging/SL positioning procedures at 626. The location information of Reference WTRUs may be shared to WTRU 1 650₁. Before performing Ranging/SL positioning procedures at 626, WTRU 1 650₁ and the selected References WTRU(s) may setup PC5 connection(s) if there is no PC5 connection currently available for SL positioning.

WTRU 1 650₁ may send SL positioning result to LMF 605 at 628.

LMF 605 may determine the location of WTRU 1 650₁ based on the received SL positioning result and known location of the reference WTRUs. If needed, LMF 605 may perform Uu positioning with the reference WTRU, if the reference WTRU is available for Uu positioning with LMF 605. LMF 605 may send WTRU 1's 650₁ location to AMF 620 at 632 as requested.

AMF 620 may send the location of WTRU 1 650₁ to the indicated destination in the received Location Request at 634.

Alternatively, or additionally, the determination of the location of the target WTRU may be performed by LMF 605, target WTRU or other location server (in a WTRU or in a NW entity). When the determination of location is performed by the target WTRU, WTRU 1 650₁ may send the determined location information to LMF 605. Further signaling exchange may be made if LMF 605 or WTRU 1 650₁ request further information to determine more precisely the location of WTRU 1 650₁. When a determination of location is performed by other location server(s), WTRU 1 650₁ or LMF 605 may send the SL positioning result and other information, for example, such as location information of reference WTRUs to the location server. After the location server determines the location information of WTRU 1 650₁, the location server may send the location information to LMF 605.

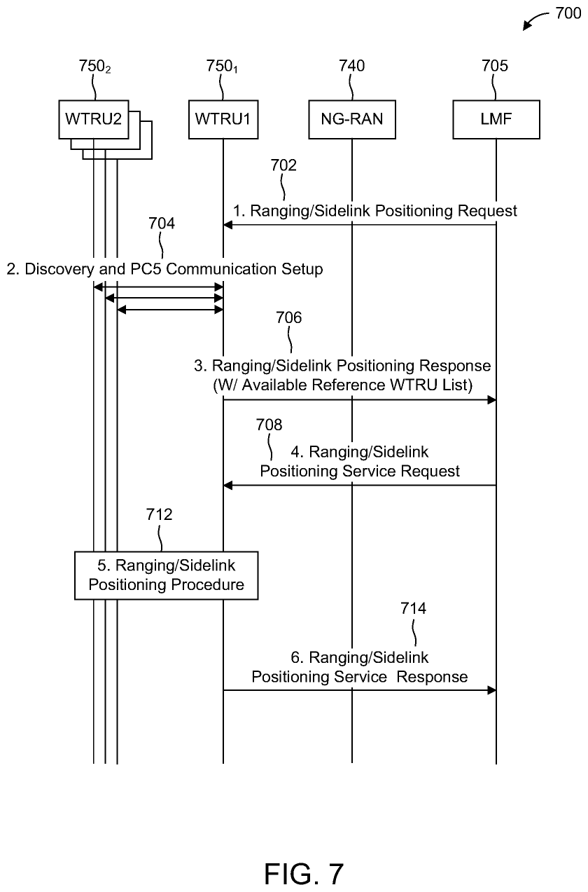

FIG. 7 illustrates the signaling 700 associated with a positioning method update procedure. LMF 705 may send Ranging/SL positioning Service Request at 702 to WTRU 1 750₁. LMF may indicate selected positioning method based on known WTRU 1's 750₁ capability (e.g., supported positioning methods such as DL-TDOA, DL-AOA, etc.) and requested QoS requirement, if available. LMF 705 may include QoS requirements in Ranging/SL positioning Service Request. LMF 705 may provide a list of potential Reference WTRUs per WTRU's location and information needed to discover and set PC5 connection.

In order to perform SL positioning as requested by LMF 705, WTRU 1 750₁ may attempt to discover reference WTRUs and perform PC5 connection setup at 704. When provided with list of potential Reference WTRUs, WTRU 1 750₁ attempts to discover those Reference WTRUs. Alternatively, WTRU 1 750₁ may defer setting up PC5 connection with discovered WTRUs later for example after receiving SL positioning Service Request from LMF 705, which may include selected positioning method and/or a selected list of reference WTRUs

When the discovered reference WTRUs are not sufficient to perform the requested SL positioning, WTRU 1 750₁ may indicate that it cannot perform SL positioning as requested. WTRU 1 750₁ may include the identity of available reference WTRU's list at 706. When determining whether SL positioning will be successful or not, it may be considered that requested QoS requirements may be satisfied with discovered reference WTRUs, if QoS requirements are available, for example, by sharing, configured, or available by other method.

When LMF 705 receives a response at 706, which includes that WTRU 1 750₁ is unable to perform SL positioning as requested, LMF 705 may select another positioning method based on QoS requirement, WTRU 1's 750₁ capability on SL positioning, and available reference WTRU's list if provided from WTRU 1 750₁. LMF 705 may select a list of reference WTRUs among ones in the list to join for SL positioning with WTRU 1 750₁. When LMF 705 selects a list of reference WTRUs, LMF 705 may select reference WTRUs as required for the selected QoS, more reference WTRUs than the required for the selected QoS, or all the reference WTRUs on the list. After selecting a positioning method, LMF 705 may send assistance information to the selected Reference WTRUs for SL positioning with WTRU 1 750₁. LMF 705 may send Ranging/SL positioning Service Request to WTRU 1 750₁. LMF 705 may indicate a selected positioning method at 708. LMF 705 may include a selected list of reference WTRUs. If the selected list of reference WTRUs is not included in the request from LMF 705, WTRU 1 750₁ may consider every reference WTRU included in the request will be involved in SL positioning. For example, the assistance information may include information about selected reference signals which are to be used for positioning with the selected positioning method such as DL-TDOA, DL-AOA, etc. For example, the assistance information may include information that is used by the WTRU for communicating with at least one WTRU that is selected from the list. Communicating with one at least one WTRU that is selected from the list may include performing a sidelink positioning procedure with the at least one WTRU that is selected from the list. For example, the assistance information may include information that is used by the WTRU to receive a reference signal from WTRU that is selected from the list and use information from the reference signal in a location calculation.

WTRU 1 750₁ and the selected References WTRUs may perform Ranging/SL positioning procedures at 712. Location information of Reference WTRUs may be shared to WTRU 1 750₁. Before performing Ranging/SL positioning procedures at 712, WTRU 1 750₁ and the selected References WTRU(s) may setup PC5 connection(s) if there is no PC5 connection currently available for SL positioning.

WTRU 1 750₁ may send SL positioning result to LMF 705 at 714.

Alternatively, or additionally, to the above, LMF 705 may send a list of SL positioning methods. The list may be ordered in reference or may be with preference value. LMF 705 may provide a required or recommended number of reference WTRUs for each SL positioning method. Based on the list, preference of methods, number of available Reference WTRUs, and comparison with the provided number of required or recommended number of reference WTRUs for each method, if available, the target WTRU may decide SL positioning methods which may achieve best QoS in a given situation. The target WTRU may report the result to LMF 705 of the selected or used SL positioning method.

Alternatively, or additionally, the determination of the location of the target WTRU may be performed by LMF 705, target WTRU or other location server (in a WTRU or in a NW entity). When a determination of location is performed by the target WTRU, WTRU 1 750₁ may send the determined location information to LMF 705. Further signaling exchanges may be made if LMF 705 or WTRU 1 750₁ exchange further information to determine the precise location of WTRU 1 750₁. When a determination of location is performed by another location server, WTRU 1 750₁ or LMF 705 may send SL positioning result and other information, for example. The other information may include location information of the reference WTRUs to the location server. After the location server determines the location information of WTRU 1 750₁, the location server may send the location information to LMF 705.

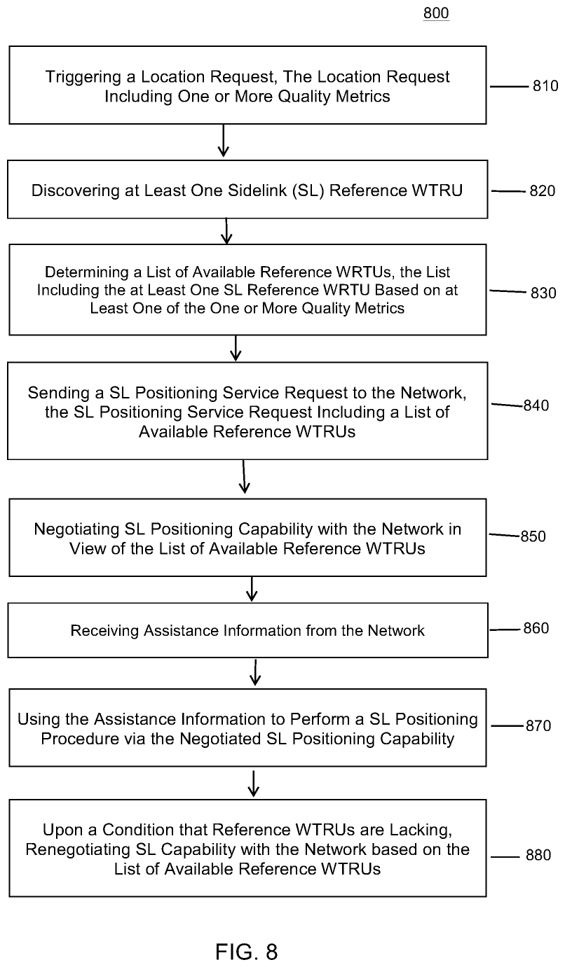

FIG. 8 illustrates a method 800 of sidelink (SL) positioning in a wireless transmit receive unit (WTRU). Method 800 includes triggering a location request at 810. The location request may include one or more quality metrics. At 820, method 800 includes discovering at least one SL reference WTRU. The discovered at least one SL reference WTRU may be identified in a mobile originated location request. At 830, method 800 includes determining a list of available reference WTRUs. The list may include the at least one SL reference WTRU based on at least one of the one or more quality metrics, for example. At 840, method 800 includes sending a SL positioning service request to the network, the SL positioning service request including a list of available reference WTRUs. At 850, method 800 includes negotiating SL positioning capability with the network in view of the list of available reference WTRUs. At 860, method 800 includes receiving assistance information from the network. At 870, method 800 includes, using the assistance information to perform a SL positioning procedure via the negotiated SL positioning capability. At 880, method 800 may include, upon a condition that reference WTRUs are lacking, renegotiating SL positioning capability with the network based on the list of available reference WTRUs.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of sidelink (SL) positioning in a wireless transmit receive unit (WTRU), the method comprising:
triggering a location request;
discovering at least one SL reference WTRU;
determining a list of available references WTRUs, wherein the list includes the at least one SL reference WTRU, the inclusion of the at least one SL reference WTRU being based on at least one or more quality metrics;
sending a SL positioning service request to a network, the SL positioning service request including the list of available reference WTRUs;
negotiating SL positioning capability with the network in view of the list of available reference WTRUs;
receiving assistance information from the network; and
performing, using the assistance information, a SL positioning procedure via the negotiated SL positioning capability.

2. The method of claim 1, wherein the discovered at least one SL reference WTRU being identified in a mobile originated location request.

3. The method of claim 1, further comprising, upon a condition that reference WTRUs are less than a threshold, renegotiating SL positioning capability with the network based on the list of available reference WTRUs.

4. The method of claim 1, wherein the one or more quality metrics comprises at least one of accuracy, response time, and LCS QoS class.

5. The method of claim 1, wherein the assistance information comprises information for communicating with at least one WTRU from the list of available reference WTRUs.

6. The method of claim 1, wherein the assistance information comprises acquisition assistance data.

7. The method of claim 1, wherein the using of the assistance information comprises utilizing at least one of accessible sources of positioning, measures, and processes of positioning signals.

8. The method of claim 1, further comprising computing the position of the WTRU in two or more dimensions.

9. The method of claim 8, further comprising reporting the position to the network.

10. The method of claim 1, wherein the negotiating SL positioning capability with the network comprises:
sending a request comprising a preferred capability and a list of supported capabilities; and
receiving a response to the sent request indicating a SL positioning procedure.

11. The method of claim 1, further comprising:
receiving a signal indicating one or more priority levels associated with SL positioning procedures; and
selecting a SL positioning procedure based on the indicated one or more priority levels.

12. The method of claim 11, wherein the indicating and selecting are performed via the network.

13. A wireless transmit receive unit (WTRU) for sidelink (SL) positioning, the WTRU comprising:
a processor; and
a transceiver communicatively coupled to the processor,
the processor and transceiver operating to:
trigger a location request;
discover at least one SL reference WTRU;
determine a list of available references WTRUs, wherein the list includes the at least one SL reference WTRU, the inclusion of the at least one SL reference WTRU being based on at least one or more quality metrics;
send a SL positioning service request to a network, the SL positioning service request including the list of available reference WTRUs;
negotiate SL positioning capability with the network in view of the list of available reference WTRUs;
receive assistance information from the network; and
perform, using the assistance information, a SL positioning procedure via the negotiated SL positioning capability.

14. The WTRU of claim 13, wherein the processor and transceiver further operate to, upon a condition that reference WTRUs are less than a threshold, renegotiate SL positioning capability with the network based on the list of available reference WTRUs.

15. The WTRU of claim 13, wherein the one or more quality metrics comprises at least one of accuracy, response time, and LCS QoS class.

16. The WTRU of claim 13, wherein the assistance information comprises information for communicating with at least one WTRU from the list of available reference WTRUs.

17. The WTRU of claim 13, wherein the assistance information comprises acquisition assistance data.

18. The WTRU of claim 13, wherein the processor and transceiver further operate to:
compute the position of the WTRU in two or more dimensions, and
report the position to the network.

19. The WTRU of claim 13, wherein the negotiating SL positioning capability with the network comprises the processor and transceiver further operating to:
send a request comprising a preferred capability and a list of supported capabilities; and
receive a response to the sent request indicating a SL positioning procedure.

20. The WTRU of claim 13, wherein the processor and transceiver further operate to:
receive a signal indicating one or more priority levels associated with SL positioning procedures; and
select a SL positioning procedure to use based on the indicated one or more priority levels.
